(19) United States
(12) Patent Application Publication
(10) Pub. No.: US 2004/0212872 A1
(43) Pub. Date: Oct. 28, 2004

(54) Optical signal processing system and method

(76) Inventors: Jean-Luc Auge, Harlow (GB); Ricardo Feced, Sawbridgeworth (GB)

Correspondence Address: William M. Lee, Jr., Barnes & Thornburg, P.O. Box 2786, Chicago, IL, 60690-2786, US

(21) Appl. No.: 10/397,020

(22) Filed: Mar. 25, 2003

(51) Int. Cl. H01S 3/00

(52) U.S. Cl. 359/333

(57) ABSTRACT

Embodiments of the present invention relate to an optical signal processing system and method that uses, for example, four-wave mixing to produce a wavelength converted optical data-bearing signal having a power level that is proportional to at least the square of the power level of an optical data-bearing signal.

### FIELD OF THE INVENTION

The present invention relates to optical signal processing systems and methods and, more particularly, to wavelength converter systems and methods.

Background to the Invention

Long haul fibre optic transmission systems often suffer with attenuation loss and consequently amplifier noise, which adversely affects the signal. A further disadvantage of such systems is dispersion, which manifests itself as pulse broadening. Dispersion can be compensated using opposite dispersion fibre modules, whereas amplifier noise can only be addressed by signal regeneration. Therefore, network wavelength converters need to perform regeneration if the signal is to be redirected and further transmitted.

Among the various techniques that may be employed to perform wavelength conversion is, for example, four-wave mixing. Conventional wavelength converters use four-wave mixing to produce a wavelength-translated signal from an optical data-bearing signal and an optical pump signal. Such converters exploit non-linear optics to achieve the mixing and translation. FIG. 1 schematically shows a frequency domain representation 100 of four-wave mixing of an optical data-bearing signal 102 and an optical pump signal 104 to produce an idler signal 106, otherwise known as a wavelength converted signal. Tlie idler signal 106 comprises optical energy that is dependent on both the optical data-bearing signal 102 and the optical pump signal 104. For example, in the case where the mixing element is a length of a non-linear optical fibre, that is, an optical dispersion shifted fibre that is operated such that non-linear effects are enhanced, the optical power of the idler signal 106 is proportional to the square of the optical power of the pump signal 104 and proportional to the power of the optical data-bearing signal 102. It can be appreciated that the frequency, ω_{c}, of the idler signal is given by ω_{c}=2ωₚ−ωₛ, where ωₚ is the frequency of the optical pump signal and ωₛ is the frequency of the optical data-bearing signal.

As will be appreciated by one skilled in the art, the wavelength-converted signal 106 derives most of its power from the optical pump signal 104. However, since the relationship between the power of the wavelength converted signal and the power of optical data-bearing signal is substantially linear, there is limited scope for regeneration and reshaping of the optical data-bearing signal.

Limited all-optical regeneration has been implemented in All-optical limiter using gain-flattened fibre parametric amplifier, Y. SU, L. Wang, A. Agarwal and P. Kumar, ELECTRONICS LETTERS 22nd Jun. 2000, VOL. 36 No. 13, which relies on pump power depletion to clamp amplitude fluctuations on the ‘ones’ of the optical data-bearing signal. However, it does not address noise fluctuations on the ‘zeros’ and, moteover, such a pump depletion is extremiely difficult to achieve since it is conditioned to a high conversion efficiency of the process. An additional disadvantage is that the operating point needs to be finely tuned so that pump depletion does not reduce the overall efficiency.

Furthermore, continuous wave (CW) optical signals are usually used as optical pump signals to provide sufficient power in an effective manner to bring into effect the non-linear transfer characteristics of, for example, highly non-linear fibres (HNLF) used in such techniques. However, using such CW optical signals does not assist in establishing any retiming or reshaping of the received optical signals.

It is an object of embodiments of the present invention at least to mitigate some of the problems of the prior aft.

### SUMMARY OF INVENTION

Accordingly, a first aspect of embodiments of the present invention provides an optical signal processing system comprising a non-linear optical material arranged to receive an optical data-bearing signal and an optical pump signal; the nonlinear optical material being operable, responsive to the optical data-beating signal and the optical pump signal, to produce a wavelength converted optical data-bearing signal having a power level that is substantially proportional to at least the square of the power level of the optical data-bearing signal; the system further comprising a filter arranged to pass said wavelength converted optical data-bearing signal.

Advantageously, the power of the, wavelength converted optical data-bearing signal of interest is influenced in a non-linear manner by the optical data-bearing signal unlike the prior art. Furthermore, there is some scope for at least regeneration of the optical data-bearing signal since the power of such a wavelength converted signal is proportional to at least the square of the power of the optical data-bearing signal.

Preferably, the non-linear optical material is the core of a fibre optic cable but embodiments also provide an optical signal processing system in which the non-linear optical material comprises any non-linear material based on a χ₃ effect.

In preferred embodiments, the power level of the wavelength converted optical data-bearing signal is substantially proportional to the power level of the optical pump signal.

A second aspect of embodiments of the present invention provides an optical signal processing system comprising a non-linear optical material arranged to receive an optical data-bearing signal and an optical pump signal; the non-linear optical material being operable, responsive to the optical data-bearing signal and the optical pump signal, to produce a wavelength converted optical data-bearing signal comprising frequencies substantially centred at 2 ωₛ−ωₚ, where ωₛ is the frequency of the optical data-bearing signal and mp is the frequency of the optical pump signal; and a filter arranged to pass said frequencies to produce an optical data signal.

A third aspect of embodiments of the present invention provides a wavelength converter and 3R regenerator comprising a non-linear optical material arranged to receive an optical data-bearing signal and a modulated optical pump signal; the non-linear optical material being operable, responsive to the optical data-bearing signal and the optical pump signal, to produce a wavelength converted optical data-bearing signal having third order harmonics of the fundamental frequencies of the optical data-bearing signal and the optical pump signal with a power level that is substantially proportional to at least the square of the power level of the optical data-bearing signal; and a filter arranged to pass said frequencies of the third order harmonics to produce a wavelength converted, regenerated, optical data signal.

A fourth aspect of embodiments of the present invention provides an optical signal processing method comprising the steps of exciting a non-linear optical medium with at least an optical data-bearing signal in the presence of a further optical signal to produce, via non-linear mixing within the non-linear optical medium of the optical data-bearing signal and the further optical signal, a wavelength converted optical data-bearing signal; and filtering the wavelength converted optical data-bearing signal to extract at least a third order harmonic of the optical data-bearing signal and the further optical signal; the third order harmonic having a power level that is substantially non-linear with respect to the power level of the optical data-bearing signal.

It will be appreciated that within non-linear optics, there are still linear optical effects, which can undesirably affect the performance of the system. Suitably, embodiments provide an optical signal processing system in which the optical data-bearing signal has a wavelength that is related or substantially equal to a zero dispersion wavelength of the non-linear optical material.

The non-linear phase mismatch among the mixing waves is often thought of as being undesirable. However, embodiments of the present invention provide an optical signal processing system in which the wavelength converted optical data-bearing signal comprises a power level that is substantially influenced by non-linear phase mismatch to achieve regeneration.

Preferably, embodiments provide an optical signal processing system further comprising means to influence a non-linear relationship component of the power level of the wavelength converted optical data-bearing signal; the component being derived from the non-linear phase mismatch between the optical data-bearing signal and the optical pump signal.

Preferred embodiments are arranged such that the means to influence the non-linear phase relationship component comprises means to vary the power levels of at least one of the optical data-bearing signal and the optical pump signal. Preferably, the peak power levels of the optical data-bearing signal and the optical pump signal are related by 2P_{S}-P_{P}=0, where P_{S} is the peak power level of the optical data-bearing signal and P_{P} is the peak power level of the optical pump signal, and the means to vary the power levels strives at least to vary, and, preferably, optimise die product (γz/2)*(2P_{S}−P_{P}).

It is desirable in embodiments of the present invention that the optical data-bearing signal has sufficient power to excite the non-linear material. Suitably, embodiments provide an optical signal processing system further comprising an amplifier to amplify a received optical data-bearing signal to produce the optical data-bearing signal.

Preferably, embodiments provide a method further comprising the steps of amplifying or attenuating at least one of the optical data-bearing signal and the further optical signal so that their respective peak power levels have a predetermined relationship to one another.

Preferably, embodiments provide a method in which the predetermined relationship is γz/2(2P_{S}−P_{P})=π for ‘zeros’ of the optical data-bearing signal, or γz/2(2P_{S}−P_{P})=0 for signal ‘ones’ of the optical data-bearing signal, where Ps is the peak power level of the optical data-bearing signal, P_{P} is the peak power level of the further optical signal and

$$γ = \frac{2 π \cdot {n}_{2}}{λ \cdot {A}_{eff}}$$

characterises the non-lineaity of the medium or material.

Retiming of an optical signal is desirable. Suitably, embodiments of the present invention provide an optical signal processing system in which the optical pump signal is modulated to have a predetermined modulation period derived from the optical data-bearing signal. Preferably, the period is arranged to match substantially the period or any sub-multiple of the period of the optical data-bearing signal.

Preferably, the wavelength converter comprises a clock recovery circuit to derive the modulated optical pump signal from the optical data-bearing signal. In preferred embodiments, the clock recovery circuit comprises means to produce a modulated optical pump signal having at least one of a duty cycle and time period derived from at least one of the duty cycle and time period of the optical data-bearing signal.

Preferred embodiments provide a method further comprising the steps of ensuring that the further optical signal is modulated to have characteristics derived from characteristics of the optical data-bearing signal.

Preferred embodiments provide an optical signal processing system further comprising means operable to ensure that the non-linear material produces at least one of cross phase modulation between or self phase modulation of the optical data-bearing signal and the optical pump signal to influence the shape of the wavelength converted optical data-bearing signal. Preferably, any such influence is via uniform frequency broadening of the spectrum. Advantageously, reshaping of the received optical signal can be facilitated.

### BRIEF DESCRIPTION OF THE DRAWINGS

Embodiments of the present invention will now be described, by way of example only, with reference to the accompanying drawings in which:

FIG. 1 illustrates four-wave mixing according to the prior art;

FIG. 2 depicts an optical signal processing system for four-wave mixing according to a first embodiment of the present invention;

FIG. 3 illustrates the principle underlying the embodiments of the present invention; and

FIG. 4 shows a graph of the transfer function of embodiments of the present invention.

### DETAILED DESCRIPTION OF THE PREFERRED EMBODIMENTS

FIG. 2 shows an optical signal processing system 200 for four-wave mixing of an optical data-bearing signal 202 and a modulated optical pump signal 204. The optical data-bearing signal 202 is split, using an optical power divider 206, into first 208 and second 210 optical signals. The first optical signal 203 is converted to an electrical signal 212 via a suitable electro-optical converter 214. The electrical signal 212 is fed to a clock recovery circuit 216, which is used to produce a clock signal 218 having a duty cycle and bit period substantially identical to, or sub-multiples of, those of the optical data-bearing signal 202. The clock signal 218 is used to control al optical pump signal source 220 to produce the modulated optical pump signal 204.

The second optical signal 210 and the modulated optical pump signal 204 are, preferably, combined using an optical power combiner 222 and then amplified, using an optical amplifier 224, to produce an amplified combined optical signal 226. The amplified combined optical signal 226 is fed into a non-linear optical material or medium, preferably, in a form of a length of highly non-linear fibre optic cable 228. The length of the fibre optic cable is sufficient to allow appreciable third order non-linear optical effects to manifest themselves. The fibre optic cable 228 gives effect to four-wave mixing of the second optical signal 210 and the modulated optical pump signal 204 or, more accurately, the amplified combined signal 226, to produce at least a wavelength converted optical signal 230. The wavelength converted optical signal 230 is filtered by a filter 232 to produce a wavelength converted optical data-bearing signal 234 having a power level and characteristics that are primarily derived from, or that reflect, the optical data-bearing signal 202. Preferably, the fibre optic cable has zero dispersion for the wavelengths of interest.

The power levels of the components of the combined signal 226 fed into the fibre optic cable 228 are arranged so that the portion of the combined signal 226 corresponding to an amplified version of the second optical signal 210 acts as an optical pump signal and the filter 232 is arranged to select the frequency components of the wavelength converted signal 230 that have power levels that are proportional to the square of the power level of the second optical signal 210 and, preferably, proportional to the power level of the modulated optical pump signal 204. These frequency components are given by 2ωₛ−ωₚ, where ωₛ is the fundamental frequency of the optical data-bearing signal and ωₚ is the fundamental frequency of the optical pump signal.

The non-linear relationship between the power level of the wavelength converted optical data-bearing signal and the power level of the optical data-bearing signal assists in clamping the zeros in the former, which positively influences the reshaping of the wavelength converted signal.

The modulated optical pump signal and the optical data-bearing signal have sufficient power so that self phase and cross phase modulation results. Therefore, it will be appreciated that any such cross phase modulation will be transferred to the wavelength converted optical data-bearing signal. This will have the effect of broadening the pulses of the wavelength converted optical data-bearing signal, which, in turn, facilitates pulse reshaping by filtering. Any such broadening results in the converted optical data signal exhibiting a square-shaped optical spectrum, which provides at least one of regeneration and reshaping when filtered with a subsequent offset from the carrier frequency.

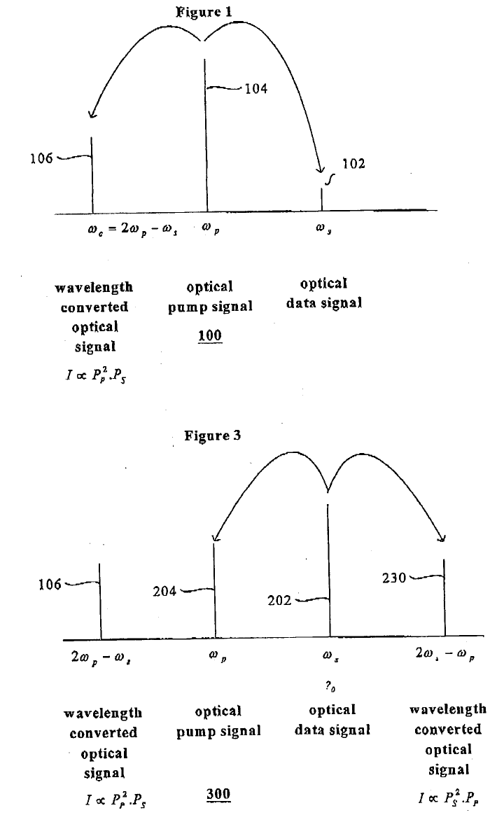

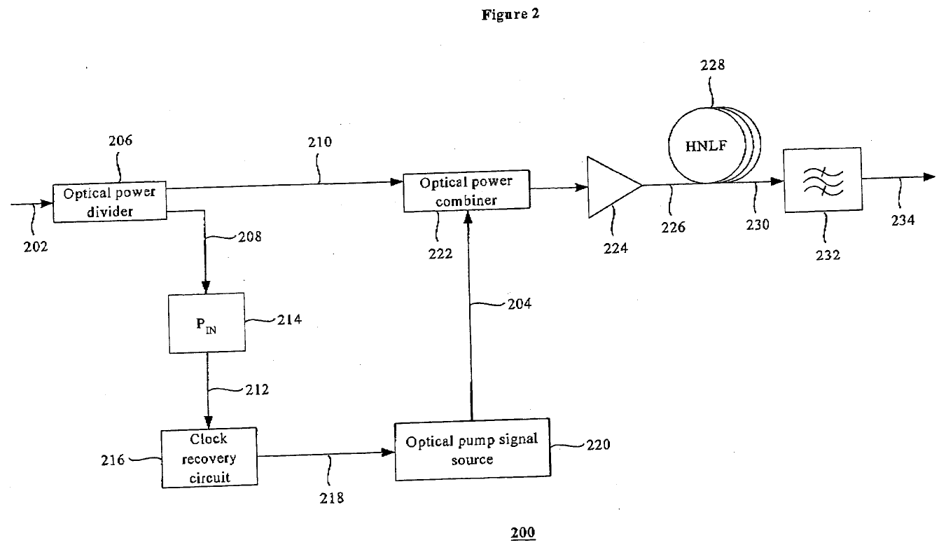

Referring to FIG. 3, there is shown a frequency domain representation 300 of the wavelength conversion that takes place using the optical system 200 according to the first embodiment Even though it can be appreciated that the amplified combined optical signal 226 has frequency components that are derived from the optical data-bearing signal or, more accurately, from the second optical signal 210, and the modulated optical pump signal 204, for simplicity, the principle of operation of the optical signal processing system 200 will be described with reference to the optical data-bearing signal 202 and the modulated optical pump signal 204. It can be appreciated from the frequency-domain representation 300 shown in FIG. 3 that the optical data-bearing signal 202 is arranged to act as an optical pump for the length of fibre optic cable 228. Four-wave mixing of the optical data-bearing signal 202 and the modulated optical pump signal 204 produces, as in the prior art, an idler signal 106, which is not of interest in the first embodiment. Four-wave mixing also produces the wavelength converted optical signal 230 at a wavelength of 2ω_{S}-ω_{P}, where ω_{S} is the wavelength of the optical data-bearing signal 202 and ωₚ is the wavelength of the optical pump signal 204. The power level of the wavelength converted optical signal 230 is proportional to the square of the power level of the optical data-bearing signal 202 and is proportional to the power level of the modulated optical pump signal 204. Filtering the wavelength converted optical signal 230 produces the wavelength converted optical data-bearing signal 234.

It can be shown that the power of the wavelength converted signal that results from four-wave mixing is given by equation (1) below

$${P}_{c} = {γ}^{2} \cdot {P}_{s}^{2} \cdot {P}_{p} \cdot {ⅇ}^{- α Z} \frac{( 1 - {ⅇ}^{- α Z} )}{{α}^{2} + Δ {{k}^{′}}^{2}} ( 1 + \frac{4 \cdot {ⅇ}^{- α Z} {sin}^{2} ( Δ {k}^{′} \cdot Z / 2 )}{{( 1 - {ⅇ}^{- α Z} )}^{2}} ) \qquad ( 1 )$$

where

Δk′=Δk+γ(2Pₛ−Pₚ), (2)

P_{c} is the peak power of the wavelength converted optical signal,

Pₛ is the peak power of the optical data-bearing signal, which is used as a pump,

Pₚ is the peak power of the optical pump signal,

α is the attenuation factor,

γ is the fibre non-linear coefficient,

Δk is the linear phase mismatch, and

z is the fibre length.

A simplification of expression (1), obtained by neglecting the fiber attenuation, gives the so-called phase mismatch term:

sin²[(Δk+γ(2Pₛ−Pₚ))·Z/2] (3)

so that (1) is reformulated as

$${P}_{c} \approx {γ}^{2} {P}_{s}^{2} {P}_{p} {z}^{2} \frac{{sin}^{2} ( Δ {k}^{′} z / 2 )}{Δ {k}^{′} z / 2} \approx {γ}^{2} {P}_{s}^{2} {P}_{p} {z}^{2} sin {c}^{2} ( Δ {k}^{′} z / 2 )$$

It can be appreciated that the efficiency of the conversion process, that is, the efficiency of the power transfer between the optical data-bearing signal and the optical pump signal to the wavelength converted signal, is affected by the non-linear phase mismatch, which is influenced by

$$\frac{γ z}{2} \cdot \vert 2 {P}_{S} - {P}_{P} \vert . \qquad ( 4 )$$

Maximum efficiency or power transfer occurs under non-linear phase matching conditions, that is, when

$$\frac{γ z}{2} \cdot \vert 2 {P}_{S} - {P}_{p} \vert = 0 ,$$

which assists in clamping tie ‘ones’ of the optical data-bearing signal.

Minimum efficiency occurs when the non-linear phase mismatching of expression (3) is minimum, that is, when

$$\frac{γ z}{2} \cdot \vert 2 {P}_{S} - {P}_{p} \vert = π .$$

This situation assists in further clamping the ‘zeros’ where Pₛ=0, which leads to the required pump peak power:

$${P}_{p} = \frac{2 π}{γ z}$$

and therefore a required signal peak power:

$${P}_{s} = \frac{{P}_{p}}{2} = \frac{π}{γ z} .$$

It will be appreciated that deriving at least one of, and preferably both of, the period and duty cycle of the modulated optical pump signal from the optical data-bearing signal 202 influences the retiming and reshaping of the wavelength converted optical data-bearing signal.

Although the above embodiments have been described with reference to the optical amplifier 224 varying, preferably, amplifying, the combined optical data-bearing signal and the modulated optical pump signal, embodiments are not limited to such an arrangement. Embodiments can be realised in which only the optical data-bearing signal is varied, preferably, amplified, and the optical pump signal source 220 is arranged to produce the modulated optical pump signal 204 at an appropriate power level.

In an embodiment the peak power level of the component of the combined signal 226 that is derived from the optical data-bearing signal 202 is 350 mW and the peak power level of the component of the combined signal 226 that is derived from the modulated optical pump signal 204 is 710 mW Under such circumstances, the amplifier may be arranged to have a gain to produce a power level of 21 dBm for the combined signal power level, which is, in effect, the application of equation (4) to a non-linear fibre with the following parameters;

core area: 12 μm²,

non-linear refractive index: n₂=2.6.10⁻²⁰ m²W⁻¹, and

wavelength: λ=1550 nm, which gives γ=10 W⁻¹.km⁻¹.

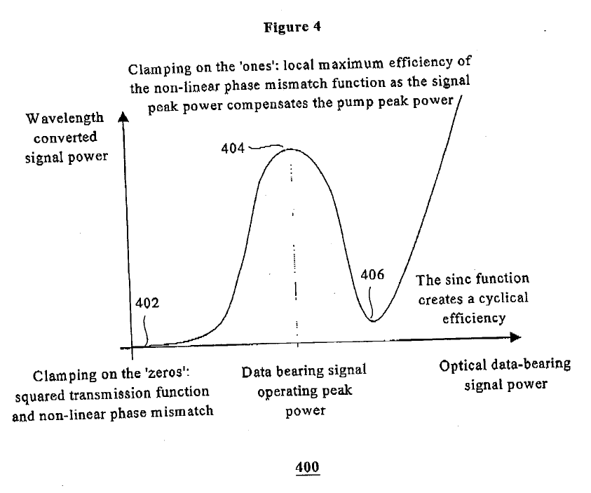

Referring to FIG. 4, there is shown a graph 400 of the transfer function of an embodiment of the present invention. It can be appreciated that the transfer function comprises a local minimum 402 that follows from the square-law relationship between the optical data-bearing signal power level and wavelength converted signal power level. This local minimum 402 assists in clamping the ‘zeros’. The transfer function also comprises a local maximum 404 that results from the non-linear phase mismatch between the optical data bearing signal and the optical pump signal. The local maximum 404 assists in clamping the ‘ones’. A further local minimum 406 is illustrated merely to demonstrate the sinc function nature of the transfer function. However, the further local minimum 406 does not play any part in clamping the zeros.

Although the above embodiments have been described with reference to the optical data-bearing signal having a wavelength that is substantially the same as the zero dispersion wavelength of the optical medium or fibre, embodiments are not limited to such an arrangement. Broadband embodiments can be realised for optical materials or fibres that have a zero dispersion slope, that is, for optical materials or fibres that exhibit zero dispersion over a range of wavelengths such as, for example, 50 nm.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings) and/or all of the steps of any method or process so disclosed, may be combined in any combination, except combinations where at least some of such features and/or steps are mutually exclusive.

Each feature disclosed in this specification (including any accompanying claims, abstract and drawings) might be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An optical signal processing system comprising a non-linear optical material arranged to receive an optical data-bearing signal and an optical pump signal; the non-linear optical material being operable, responsive to the optical data-bearing signal and the optical pump signal, to produce a wavelength converted optical data-bearing signal having a power level that is substantially proportional to at least the square of the power level of the optical data-bearing signal; and a filter arranged to pass said wavelength converted optical data-bearing signal.

2. An optical signal processing system as claimed claim 1, further comprising means to influence a non-linear phase relationship component of the power level of the wavelength converted optical data-bearing signal; the component being dependent upon the optical data-bearing signal and the optical pump signal.

3. An optical signal processing system as claimed in claim 2 in which the means to influence the non-linear phase relationship component comprises means to vary the power levels of at least one of the optical data-bearing signal and the optical pump signal.

4. An optical signal processing system as claimed in claim 3 in which the power levels of the optical data-bearing signal and the optical pump signal are related by
$$\frac{γ z}{2} \cdot ( 2 {P}_{S} - {P}_{P} ) ,$$
where P_{S} is the peak power level of the optical data-bearing signal and P_{P} is the peak power level of the optical pump signal.

5. An optical signal processing system as claimed in claim 4 in which at least one of the optical data-bearing signal peak power level and the optical pump signal peak power level is arranged to vary
$$\frac{γ z}{2} \cdot ( 2 {P}_{S} - {P}_{P} )$$
with the data of the optical data-bearing signal.

6. An optical system as claimed in claim 5, in which the at least one of the optical data-bearing signal and the optical pump signal power levels are arranged to optimise
$$\frac{γ z}{2} \cdot ( 2 {P}_{S} - {P}_{P} )$$
according to the data of the optical data-bearing signal.

7. An optical system as claimed in claim 6 in which the optical pump signal peak power is substantially amplified to a power level of
$${P}_{p} = \frac{2 π}{γ z}$$
and the optical data-bearing signal peak power is substantially amplified to a power level of
$${P}_{s} = \frac{{P}_{p}}{2} = \frac{π}{γ z}$$
such that a non-linear phase mismatch term of sinc²
$$[ \frac{γ z}{2} \cdot ( 2 {P}_{S} - {P}_{P} ) ]$$
is minimised when the data of the optical data bearing signal are ‘zeros’ and maximised when the data of the optical data bearing signal are ‘ones’.

8. An optical signal processing system comprising a non-linear optical material arranged to receive an optical data-bearing signal and an optical pump signal; the non-linear optical material being operable, responsive to the optical data-bearing signal and the optical pump signal, to produce a wavelength converted optical signal comprising frequencies substantially centred at 2ω_{S}−ω_{P}, where ω_{S} is the frequency of the optical data-bearing signal and cop is the frequency of the optical pump signal; and a filter arranged to pass said frequencies to produce a wavelength converted optical data-bearing signal.

9. An optical signal processing system as claimed in claim 8 in which the optical data-bearing signal has a wavelength that is related to or substantially equal to a zero dispersion wavelength of the non-linear optical material.

10. An optical signal processing system as claimed in claim 9, further comprising means to influence a non-linear phase relationship component of the power level of the wavelength converted optical data-bearing signal; the component being dependent upon the optical data-bearing signal and the optical pump signal.

11. An optical signal processing system as claimed in claim 10 in which the means to influence the non-linear phase relationship component comprises means to vary the power levels of at least one of the optical data-bearing signal and the optical pump signal.

12. An optical signal processing system as claimed in claim 11 in which the power levels of the optical data-bearing signal and the optical pump signal are related by
$$\frac{γ z}{2} \cdot ( 2 {P}_{S} - {P}_{P} ) ,$$
where P_{S} is the peak power level of the optical data-bearing signal and Pp is the peak power level of the optical pump signal.

13. An optical signal processing system as claimed in claim 12 in which at least one of the optical data-bearing signal and the optical pump signal peak power levels is arranged to vary
$$\frac{γ z}{2} \cdot ( 2 {P}_{S} - {P}_{P} )$$
with the data of the optical data bearing signal.

14. An optical system as claimed in claim 13, in which the at least one of the optical data-bearing signal and the optical pump signal power levels are arranged to optimise
$$\frac{γ z}{2} \cdot ( 2 {P}_{S} - {P}_{P} )$$
according to the data of the optical data bearing signal.

15. An optical system as claimed in claim 11 in which the optical pump signal power level, is varied to a predetermined power level and the optical data-bearing signal power level is varied to a predetermined power level such that a non-linear phase mismatch term of the power level of the wavelength converted optical signal is at least reduced when the data of the optical data-bearing signal are of a first data type and at least increased when the data of the optical data bearing signal are of a second data type.

16. An optical system as claimed in claim 15 in which the predetermined power level of the optical pump signal peak power is varied to be
$${P}_{p} = \frac{2 π}{γ z}$$
and the predetermined power level of the optical data-bearing signal peak power is varied to be
$${P}_{s} = \frac{{P}_{p}}{2} = \frac{π}{γ z}$$
and the such that that the non-linear phase mismatch term of sinc²
$$[ \frac{γ z}{2} \cdot ( 2 {P}_{S} - {P}_{P} ) ]$$
is minimised to null when the data of the optical data-bearing signal are ‘zeros’, and maximised to one when the data of the optical data-bearing signal are ‘ones’.

17. An optical signal processing system as claimed in any preceding claim in which the non-linear material comprises a fibre optic cable core or any χ₃ related medium.

18. An optical signal processing system as claimed in claim 8 in which the optical pump signal is modulated to have a predetermined modulation period derived from the optical data-bearing signal.

19. An optical signal processing system as claimed in claim 18 in which the predetermined modulation period is arranged to match substantially the period or any sub-multiple of the period of the optical data-bearing signal.

20. An optical signal processing system as claimed in claim 8 in which the wavelength converted optical data-bearing signal comprises a power level that is substantially proportional to at least the square of the power level of the optical data-bearing signal.

21. An optical signal processing system as claimed in claim 8 in which the power level of the wavelength converted optical data-bearing signal is substantially proportional to the power level of the optical pump signal.

22. An optical signal processing system as claimed in claim 8 further comprising means operable to ensure that the non-linear material produces at least one of cross or self phase modulation of the optical data-bearing signal and the optical pump signal to influence at least the shape of the wavelength converted optical data-bearing signal.

23. An optical signal processing system as claimed in claim 8 further comprising an amplifier to amplify a received optical data-bearing signal to produce the optical data-bearing signal.

24. A wavelength converter and 3R regenerator comprising a non-linear optical material arranged to receive an optical data-bearing signal and a modulated optical pump signal; the non-linear optical material being operable, responsive to the optical data-bearing signal and the optical, pump signal to produce a wavelength converted optical data-bearing signal having third order harmonics of the fundamental frequencies of the optical data-bearing signal and the optical pump signal with a power level that is substantially proportional to at least the square of the power level of the optical data-bearing signal; and a filter arranged to pass said third order harmonics to produce a wavelength converted, regenerated, optical data signal.

25. A wavelength converter as claimed in claim 24 further comprising a clock recovery circuit to derive the modulated optical pump signal from the optical data-bearing signal.

26. A wavelength converter as claimed in claim 25 in which the clock recovery circuit comprises means to produce the modulated optical pump signal having at least one of a duty cycle and time period derived from at least one of the duty cycle and time period of the optical data-bearing signal respectively.

27. A wavelength converter as claimed in claim 24 in which the non-linear optical material comprises a non-linear fibre with at least one of substantially zero dispersion at a predetermined wavelength or range of wavelengths and a substantially zero dispersion slope for a predetermined wavelength or range of wavelengths.

28. An optical signal processing method comprising the steps of exciting a non-linear optical medium with at least an optical data-bearing signal in the presence of a further optical signal to produce, via non-linear mixing within the non-linear optical medium of the optical data-bearing signal and the further optical signal, a wavelength converted optical data-bearing signal; and filtering the wavelength converted optical data-bearing signal to extract at least a third order harmonic of the optical data-bearing signal and the further optical signal; the third order harmonic having a power level that is substantially non-linear with respect to the power level of the optical data-bearing signal.

29. A method as claimed in claim 28 further comprising the steps of varying the power levels of at least one of the optical data-bearing signal and the further optical signal so that their respective power levels have a predetermined relationship to one another.

30. A method as claimed in claim 29 in which the predetermined relationship is
$$\frac{γ z}{2} \cdot ( 2 {P}_{S} - {P}_{P} ) = 0 or \frac{γ z}{2} \cdot \vert 2 {P}_{S} - {P}_{P} \vert = π ,$$
where P_{S} is the peak power level of the optical data-bearing signal, P_{P} is the peak power level of the further optical signal and γ characterises the non-linearity of the optical medium.

31. A method as claimed in claim 28, further comprising the steps of ensuring that the further optical signal is modulated to have, characteristics derived from characteristics of the optical data-bearing signal.
